(19) United States
(12) Patent Application Publication
(10) Pub. No.: US 2007/0169978 A1
(43) Pub. Date: Jul. 26, 2007

(54) Suspension apparatus for a wheeled vehicle utilizing offset frame with torsion shock absorber

(75) Inventors: Steven J. Patmont, Gardnerville, NV (US); James D. Robbins, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Patmont Motor Werks, Inc., Minden, NV (US)

(21) Appl. No.: 11/489,268

(22) Filed: Jul. 18, 2006

Related U.S. Application Data
(63) Continuation-in-part of application No. 11/082,211, filed on Mar. 15, 2005, now Pat. No. 7,100,729.
(60) Provisional application No. 60/554,671, filed on Mar. 16, 2004.

(51) Int. Cl. B60G 21/055

(52) U.S. Cl. 180/227; 280/124.169

(57) ABSTRACT

A wheeled vehicle includes a front steered wheel, a rear driven wheel, and a support member that supports a rider. A main structural tube is disposed substantially horizontally along a longitudinal axis for supporting the front steered wheel at a forward end of the main structural tube, for supporting the rear driven wheel at a rear end of the main structural tube, and for supporting a rider who controls and steers the wheeled vehicle. An improved torsion acting shock absorbing mount is disclosed for the cantilevered shock absorbing support of at least one of the vehicle wheels from the frame. The torsion acting shock absorber includes a square sectioned metal tube, a correspondingly square sectioned metal shaft, and confined compressible resilient compound rods acting there between. The torsion acting shock absorber is attached at right angles to the main structural tube. A cantilevered wheel support is mounted offset from the main structural tube at the end of the shock absorber remote from the main structural tube. The square tube fastens at right angles to the main structural tube while the square metal shaft connects to the cantilevered wheel support. The cantilevered wheel support torsion rotates through the shock absorber at right angles with respect to the main structural tube to undertake shock absorbing movement between at least one of the wheels and the main structural tube, and the rider.

### CROSS-REFERENCE TO RELATED APPLICATION

This application is a continuation-in-part of application Ser. No. 11/082,211, filed Mar. 15, 2005, the disclosure of which is hereby incorporated by reference.

This invention relates to wheeled vehicles. More particularly, this invention relates to a vehicle suspension adaptable to so-called offset frames where torsion shock absorbers provide both the required frame offset from which cantilevered wheels can be mounted and from which shock absorbing movement of one part of the vehicle frame relative to another part of the vehicle frame can occur.

### BACKGROUND OF THE INVENTION

All-terrain scooters are known. See Patmont, U.S. Pat. No. 6,012,539. The “all-terrain” scooter disclosed therein is provided with a large central tubular chassis having two central brackets supporting a platform. At the front, the tubular chassis bends upward through a notch in the platform upwardly and above the front wheel to support a steering wheel head tube. At the rear, the tubular frame is offset to one side of the chassis for one-sided cantilevered support of the rear driven wheel, this cantilevered support providing for economic manufacture. From this rear portion of the frame, pivotal and cantilevered mounting of an engine having a protruding shaft with a tire driving surface occurs. Generally, the scooter is driven on enlarged tires with its principal use being off-road, typically over rough terrain.

This scooter has found extensive use in both sporting and off-road patrol functions. Regarding such sporting functions, racing and jumping in both organized and unorganized individual and team competition now regularly occurs. Likewise, in off-road patrol functions, the scooter is typically transported in the trunk of the car or the bed of the truck to the end of a road, lifted from its transported disposition, assembled, and used for transport of a patrolling officer to locations where his car or truck cannot take him. In either event, improved all-terrain performance is required. In order for such all-terrain performance to occur, the ability to soften the impact of scooter takeoff and landing from terrain obstacles, such as rocks, potholes, and the like, have been required.

Referring to Martin U.S. Pat. No. 6,338,393, the rear driving wheel is shown mounted to a support bracket pivotal with respect to the rear portion of a scooter. A shock absorber extends between the scooter platform and a point above the scooter platform on the pivoting support bracket. The shock absorber absorbs energy by undergoing compression upon impact of the rear driven wheel of the scooter with the ground.

It is also known to use essentially the same arrangement and have the shock absorber extend between a pivot point underlying the platform and a lower and protruding portion of the rear wheel supporting frame.

Both arrangements have their disadvantages. Where the shock absorber is mounted above the platform, both the mount and the shock absorber are exposed to the foot of the rider. Interference with the rider's firm footing on the platform can occur. Further, the feet of the rider can be knocked out of position on the platform or the feet of the rider can damage the shock absorber. Where the shock absorber is mounted below the platform, the shock absorber is inevitably exposed to the underlying irregular terrain. Where the shock absorber is exposed to the underlying irregular terrain, the inevitable particulate matter impacting the shock absorber can interfere with shock absorber operation and even damage the shock absorber to the point of inoperability.

In both of the above examples, the shock absorber must move relative to the platform and undercarriage of the scooter during shock absorbing motion. This required motion increases the profile required for shock absorber operation relative to the top and/or bottom of the scooter.

Torsion acting shock absorbers are known. In Henschen, U.S. Pat. Nos. 5,277,450 and 5,411,287, there is disclosed a torsion axle for use as a shock absorber with trailers. Specifically, square sectioned torsion shafts, square sectioned metal tubes and a plurality of resilient rubber rods acting between the square sectioned torsion shafts and metal tubes are utilized. The resilient rubber rods are confined between the square sectioned metal tubes and the square sectioned metal shafts so as to be compressed by the square sectioned metal shaft when the square sectioned metal shaft rotates relatively to the square sectioned metal tubes. The resilient rubber rods come under compression and torsionally resist rotation of the square sectioned shafts. In a typical application, the metal tubes are attached to the trailer. The torsion shafts are attached to the wheels by an eccentric crank, which eccentric crank is off center with respect to a line extending vertically from the axis of rotation of the wheel vertically upward normal to the trailer. The crank extends outwardly and away from the metal tubes so that the wheels are supported outwardly and away from both the torsion axle and the trailer. When the trailer encounters shock inducing bumps along its path of travel, shock absorbing movement of the crank mounted wheel occurs.

We have a previous shock absorber arrangement designed for a motor powered scooter. In Patmont, U.S. Pat. No. 6,668,959, issued Dec. 30, 2003, entitled Scooter with Integral Frame Mounted Shock Absorber, there is disclosed a motor powered scooter for supporting a standing rider that has a front steered wheel, a rear driven wheel, and a platform there between that supports a standing rider on the scooter. The platform is disposed substantially horizontally along a longitudinal axis, and in the preferred embodiment has a main structural tube disposed in supporting relation under the platform. A shock absorber having first and second relatively moving ends for energy absorbing movement is fastened in fixed relation to the underside of the platform with one of the relatively moving ends disposed to and toward the rear driven wheel. In a preferred embodiment, the shock absorber is protectively encased and held within the main structural tube underlying and supporting the platform. A rear frame is provided for supporting the rear driven wheel. This rear frame is connected at a pivot relative to the platform. A linkage has a first connection to the rear frame offset from the pivot. This linkage connects at a second connection at the relatively moving end of the shock absorber. The pivot of the driving wheel supporting frame relative to the platform causes energy absorbing shock absorber movement.

Discovery of Design Criteria

From the standpoint of an economically manufactured and functioning scooter, two design requirements are desirable. First, for the economical manufacture of the scooter, the wheels must be cantilevered with respect to the frame. Traditional fork mounting of either the front or rear axle is to be avoided.

Second, for the functioning of the scooter, it is required that the shock absorber be confined in a completely protected manner while at the same time functioning to dampen the inevitable shock which the scooter undergoes during use. It will be seen that the following disclosed design, enables these design requirements.

Insofar as the prior art does not suggest nor specifically disclose the desirability of these two design requirements, invention is claimed. The reader will understand that determining design requirements as well as meeting those design requirements can constitute invention.

### BRIEF SUMMARY OF THE INVENTION

A wheeled vehicle includes a front steered wheel, a rear driven wheel, and a support member that supports a rider. A main structural tube is disposed substantially horizontally along a longitudinal axis for supporting the front steered wheel at a forward end of the main structural tube, for supporting the rear driven wheel at the rear end of the main structural tube, and for supporting a rider who controls and steers the wheeled vehicle. An improved torsion acting shock absorbing mount is disclosed for the cantilevered shock absorbing support of at least one of the vehicle wheels from the frame. The torsion acting shock absorber includes a square sectioned metal tube, a correspondingly square sectioned metal shaft, and confined compressible rubber rods acting there between. As used herein, rubber rods or bars or other equivalent resilient substances such as natural or synthetic rubber-like substances may be used. The torsion acting shock absorber is attached at right angles to the main structural tube and protrudes at an end to one side of the main structural tube. A cantilevered wheel support is mounted offset from the main structural tube at the end of the shock absorber remote from the main structural tube. The square tube fastens at right angles to the main structural tube while the square metal shaft connects to the cantilevered wheel support. The cantilevered wheel support torsion rotates through the shock absorber at right angles with respect to the main structural tube to undertake shock absorbing movement between at least one of the wheels and the main structural tube, and the rider. Provision is made for applying the shock absorber between the cantilevered driving wheel, the cantilevered steering wheel, or both. The economical manufacture of the wheeled vehicle with cantilevered wheel mounting is enabled together with protected mounting of the torsion acting shock absorber during vehicle operation.

An advantage of this invention is that the shock absorber naturally disposes the cantilevered wheel mount away from the main structural tube. By the expedient of cantilevering the wheel from the cantilevered wheel mount back into alignment with the axis of the main structural tube, an economically constructed and wheel aligned motorized vehicle results.

A further advantage of this invention is that the torsion acting shock absorber is completely self-contained and protected from the elements.

### BRIEF DESCRIPTION OF THE DRAWINGS

FIG. 1 is a perspective side elevation of a motorized scooter constructed in accordance with this invention illustrating a scooter embodiment in which both the front steered wheel and the rear driven wheel are provided with the torsional shock absorber for the cantilevered mount of the scooter wheels;

FIG. 2 is a perspective bottom view of the motorized scooter of FIG. 1 illustrating the main structural tube, the platform supported on the main structural tube, the cantilevered mount of the rear driven wheel, and the cantilevered mount of the front steered wheel;

FIG. 3 is an expanded side elevation of the cantilevered mount of the front steered wheel here illustrating the steering tube, the under platform mount of the torsional shock absorber, and the cantilevered mount of the front steered wheel including the disposition of a disk brake on the front steered wheel;

FIG. 4 is an expanded side elevation of the cantilevered mount of the rear powered wheel here illustrating the rear cantilevered motor mounting and wheel mounting tube further illustrating the overlying motor and underlying rear driven wheel with its coaxially mounted sprocket driven from an overlying motor sprocket (schematically shown);

FIG. 5 is a typical detail of a cross-section of the torsion shock absorber of the preferred embodiment of this invention;

FIG. 6 is an exemplary side view of a two-wheeled vehicle having a seat upon which a rider can sit in which both the front steered wheel and the rear driven wheel are provided with the torsional shock absorber for the cantilevered mount of the vehicle wheels;

FIG. 7A is an exemplary perspective view of a four-wheeled vehicle in which the front steered wheels and the rear driven wheels are provided with the torsional shock absorbers for the cantilevered mount of the vehicle wheels;

FIG. 7B is a detailed view corresponding to the vehicle of FIG. 7A, shown without the seat;

FIG. 7C is top view diagram corresponding to the vehicle of FIG. 7B;

FIG. 7D is a front view diagram corresponding to the vehicle of FIG. 7B;

FIG. 7E is a side view diagram corresponding to the vehicle of FIG. 7B;

FIG. 8 is top view diagram of the frame portion of the vehicle of FIG. 7B;

FIG. 9 is a perspective view diagram showing an exploded view of one of the torsional shock absorbers for the cantilevered mount of the vehicle wheels.

FIG. 9A shows detail A corresponding to FIG. 9.

FIG. 10 is a detailed perspective view diagram of the front swing arm assembly for the vehicle of FIG. 7B.

### DETAILED DESCRIPTION OF THE INVENTION

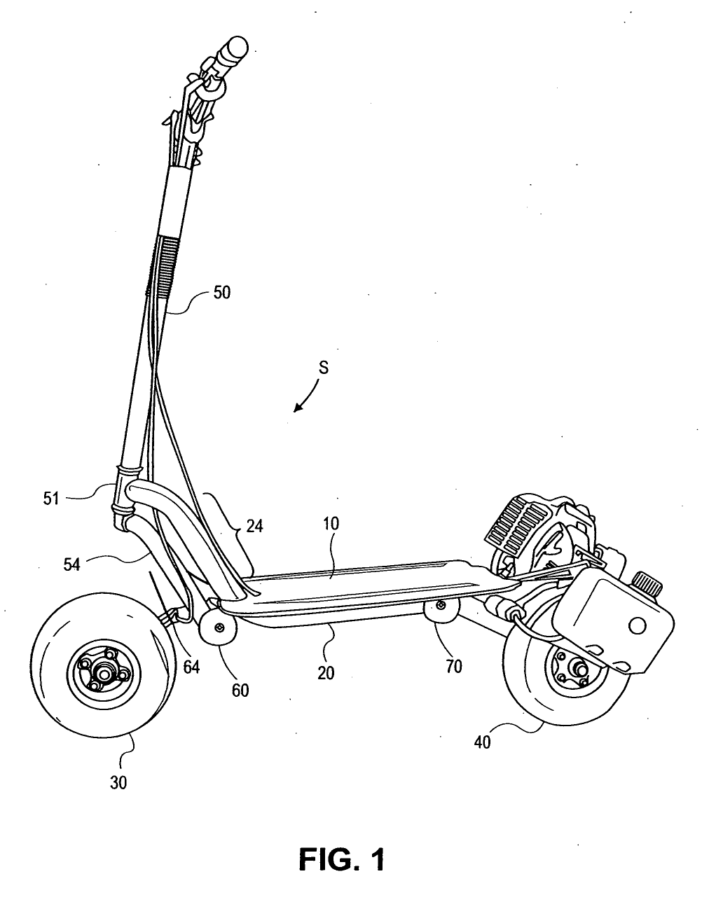

Referring to FIG. 1, scooter S is shown having platform 10, main structural tube 20, front steered wheel 30, rear driven wheel 40 and upwardly extending steering handle 50. Simply stated, a rider stands on platform 10, steers steering handle 50, and operates throttle and brake controls mounted to handle 50 for scooter operation. In the view here shown, first torsion shock absorber 60 mounts steered wheel 30 to steering handle 50 and main structural tube 20 while a second torsion shock absorber 70 mounts motor driven wheel 40 to main structural tube 20.

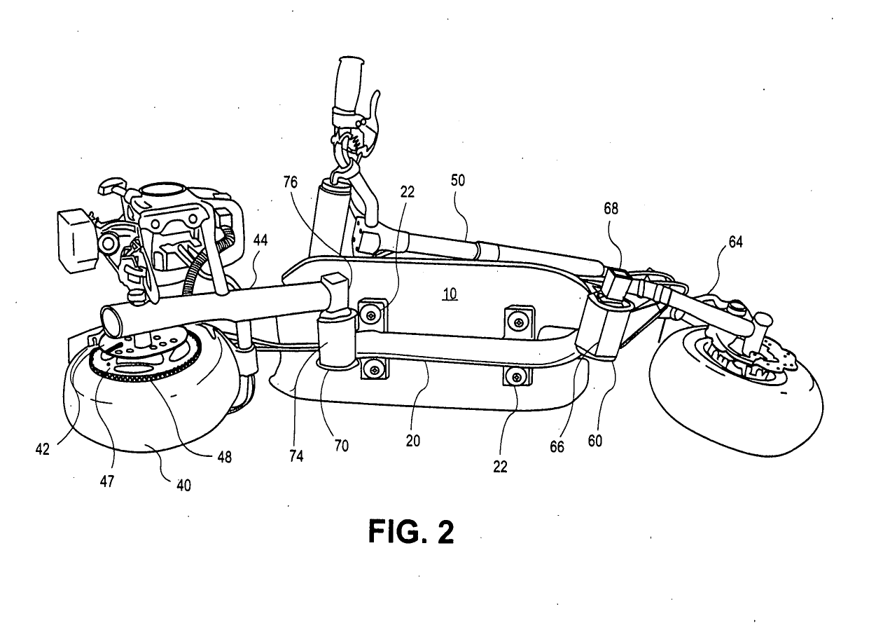

Having set forth the main elements of this invention, attention can be devoted to the bottom perspective view illustrated in FIG. 2 which conveniently illustrates the difference between the suspension system applied to the front steered wheel 30 and the rear driven wheel 40. First, main structural tube 20 supports platform 10 at respective screw pads 22. As shown in FIG. 1, structural tube 20 bends arcuately upward at arcuate bend 24 terminating at neck 51. It is from neck 51 that steered wheel 30 is controlled.

Main structural tube 20 and its underlying platform 10 attach to second torsion shock absorber 70. It is from this end of main structural tube 20 that second torsion shock absorber 70 mounts powered wheel 40.

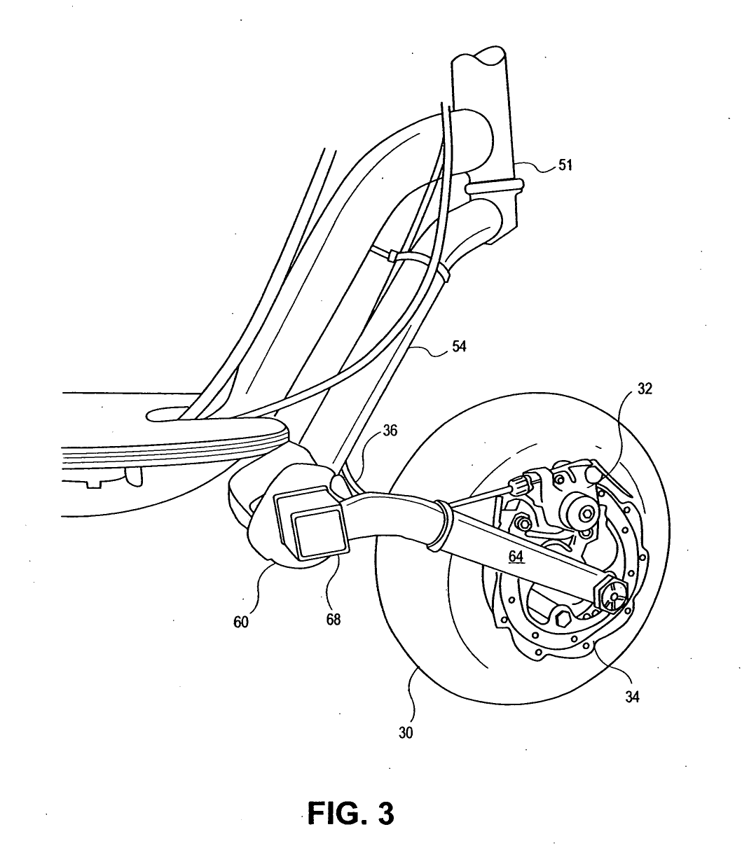

Referring to both FIGS. 1 and 2, it will be seen that front steered wheel 30 connects to upwardly extending steering handle 50 at a rotatable mount within neck 51. Steering handle 50 connects through to steering wheel offset arm 54. Referring briefly back to FIG. 1, it will be seen that arm 54 has first torsion shock absorber 60 mounted at the bottom end thereof. Referring to FIG. 2, it will be seen that the first torsion shock absorber 60 attaches at its outer end to steering wheel cantilever arm 64. Operation of steered wheel 30 is easy to understand. As upwardly extending steering handle 50 is rotated within neck 51, steering wheel offset arm 54, first torsion shock absorber 60, and steering wheel cantilever arm 64 all rotate together to steer steered wheel 30. Referring to FIG. 3, it will be seen that steering wheel offset arm 54 has a bend complementary to arcuate bend 24 of main structural tube 20 (See FIG. 1).

The cantilevered mount of steered wheel 30 can be easily identified with respect to FIGS. 2 and 3. Specifically, disk brake 32 mounted within shield 34 is controlled through cables 36 which extend upwardly of steered handle 50. Disk brake 32 is mounted between steered wheel 30 and steering wheel cantilever arm 64. It is to be noted that first torsion shock absorber 60 has its square tube 66 attached at the bottom of steering wheel offset arm 54. Likewise, first torsion shock absorber 60 has its square shaft 68 attached to steering wheel cantilever arm 64. The reader will understand that the respective positions of the square tube 66 and the square shaft 68 could as well be reversed.

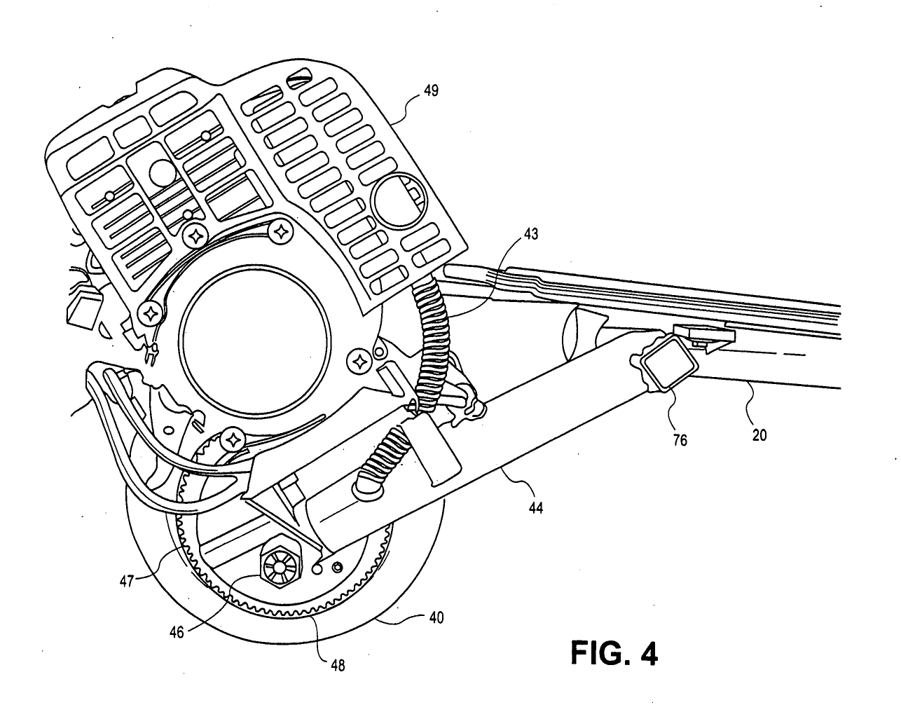

Referring to FIGS. 2 and 4, mounting of the rear driven wheel 40 is illustrated. Second torsion shock absorber 70 fastens to the rear of main structural tube 20. Square tube 74 is welded at its exterior to the end of the main structural tube 20. Square shaft 76 protrudes from second torsion shock absorber 70 and has a rear cantilever arm 44 mounted thereto. A single cantilever mount 46 mounts concentric sprocket 47, chain 48, overlying a driven sprocket (not shown) powered by engine 49. As can be seen clearly in FIG. 2, concentric sprocket 47 driven by chain 48 is placed between the driven wheel 40 and rear cantilever arm 44. As is known, cantilever arm 44 serves as portion of a muffler having exhausted conduit 43 from the engine 49 lead into cantilever arm 44. It will be further observed that the scooter here shown includes a rear disk brake 42 between powered wheel 40 and cantilever arm 44, which disk brake 42 is cable operated from steering handle 50. Likewise, the throttle to engine 49 is cable operated from steering handle 50. It is to be noted that in FIG. 2, steering handle 50 is shown in a folded position, a position well known for this type of scooter device.

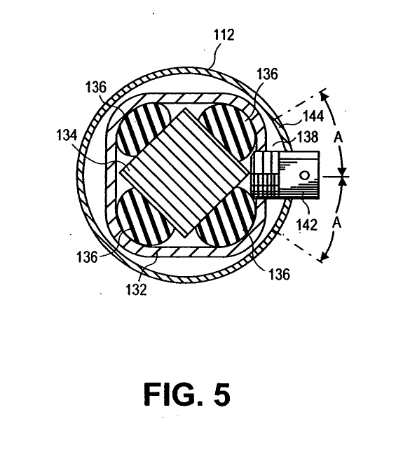

Referring to FIG. 5, a typical torsion shock absorber is shown. Tube 112 contains square tube 132. Tube 132 has square section shaft 134 extending centrally thereof. Rubber tubes 136 are trapped between the respective sides of square section shaft 134. As used herein, rubber tubes, rods or bars or other equivalent resilient substances such as natural or synthetic rubber-like substances may be used. For example, a synthetic urethane material may be used. Rotation of shaft 134 compresses rubber tubes 136 with resultant shock absorption. It can be seen that tube 112 is slotted between slots 144 extending through an angle of 2A. Shaft 142 rotates squared tube 132 enabling shock absorbing movement to occur.

Shock absorbers of the type illustrated in FIG. 5 are readily available on a commercial basis. For example, such shock absorbers may be purchased from QDS Henschen Inc. of Jackson Center, Ohio.

As is implied and inherent in the above description, it should be realized that the use of the novel suspension system having torsional shock absorber(s) disclosed herein is not solely limited for use with a powered scooter supporting a standing rider. The novel suspension system in accordance with the embodiments of the present invention can also be used with any in-lined two-wheeled vehicle including powered and non-powered bicycles and scooters having a seat, or generally a vehicle having two wheels spaced apart in the travel direction. Furthermore, the novel torsional shock absorber-based suspension system in accordance with the embodiments of the present invention can also be used with four wheeled vehicles. These other embodiments of the novel torsional shock absorber-based suspension system are described in further detail below. In addition to the economic advantages described above, the use of the torsional shock absorber-based suspension system provides several additional advantages. One advantage of using the torsional shock absorber-based suspension system is that the suspension system uses far less moving parts as compared to other two-wheeled vehicles which may use shock absorbers. The reduced number of moving parts enables a significant reduction in the cost of manufacturing the suspension system. In addition, the torsional shock absorber-based suspension system lacks the typical sticktion-force-related problems of other suspensions systems. Another advantage of the torsional shock absorber-based suspension system is that the suspension system inherently provides an anti-dive capability when used on the front wheel of a two-wheeled vehicle. This anti-dive capability adds to the safety of the vehicle when the vehicle has to suddenly decelerate or come to a sudden stop. The arrangement of the front torsion shock spring by being behind the front wheel's center is such that the downward force applied to the front wheel, for example during a sudden stop or upon hitting a depression, actually tends to stabilize the vehicle as opposed to force the vehicle into a dive. This anti-dive capability is present in the two-wheeled stand-one scooter as well as other in-line two-wheeled vehicles.

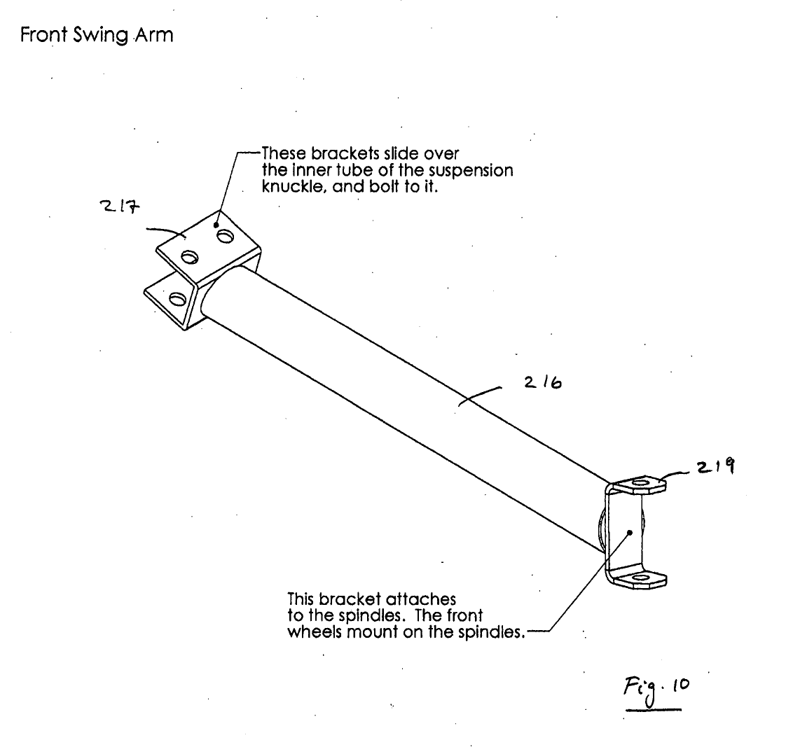

FIG. 6 shows an exemplary side view of a two-wheeled vehicle having a seat upon which a rider can sit in which both the front steered wheel and the rear driven wheel are provided with the torsional shock absorber for the cantilevered mount of the vehicle wheels. Seat 104 is connected with seat support member 102 which is connected with the platform 108 and the main horizontal structure tube 106. Tube 106 is connected with the curved member 112 which is connected with the steering column 114. The steering column extends upward and terminates at handles; the steering column extends downward and can terminate at guard 116. Guard 116 provides protection over the front wheel 114. Front wheel 114 is connected with the structural tube 106 via the torsional shock absorber 110. Wheel 112 is connected with the structural tube 106 via the torsional shock absorber 109. Also shown is a removable kick stand 118. As is shown in FIG. 6 the suspension system using the torsional shock absorber can also be used with a two-wheeled vehicle where the operator is normally in a seated position such as in the vehicle of FIG. 6, as well as motorized or non-motorized bicycles (not shown) or motorcycles. Other details of the vehicle of FIG. 6 can be appreciated by referring to the above description. Another novel aspect of the torsional shock absorbers in accordance with the embodiments of the present invention is directed to the pre-compression of the elastomeric material of the shock absorber. This novel pre-compression is described below in and shown in FIG. 9.

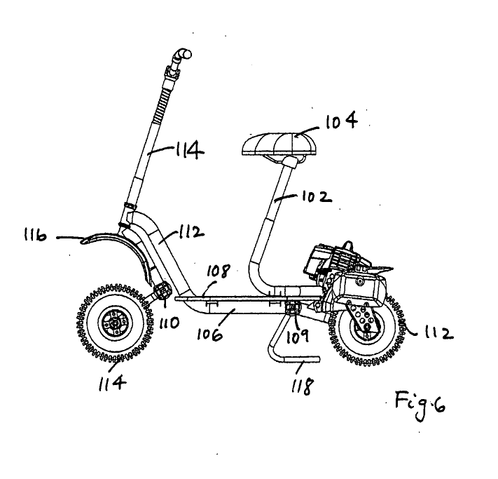

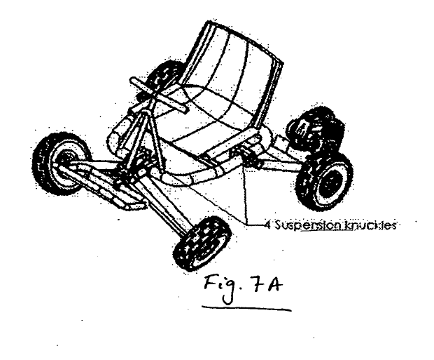

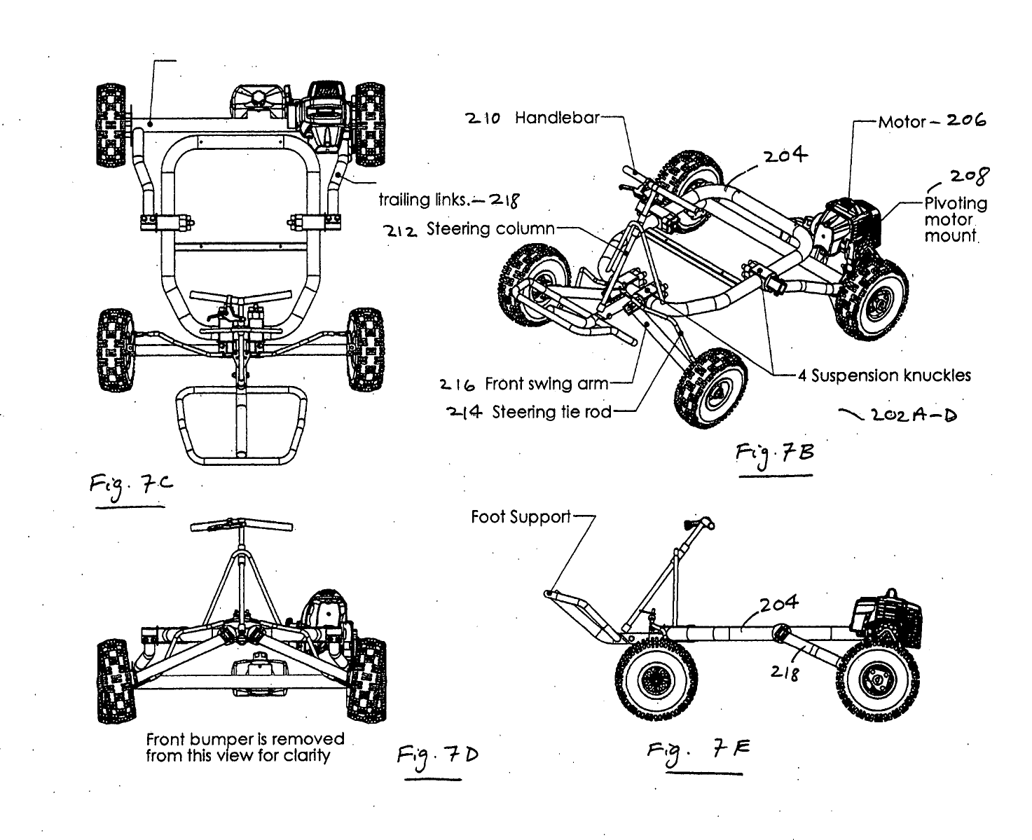

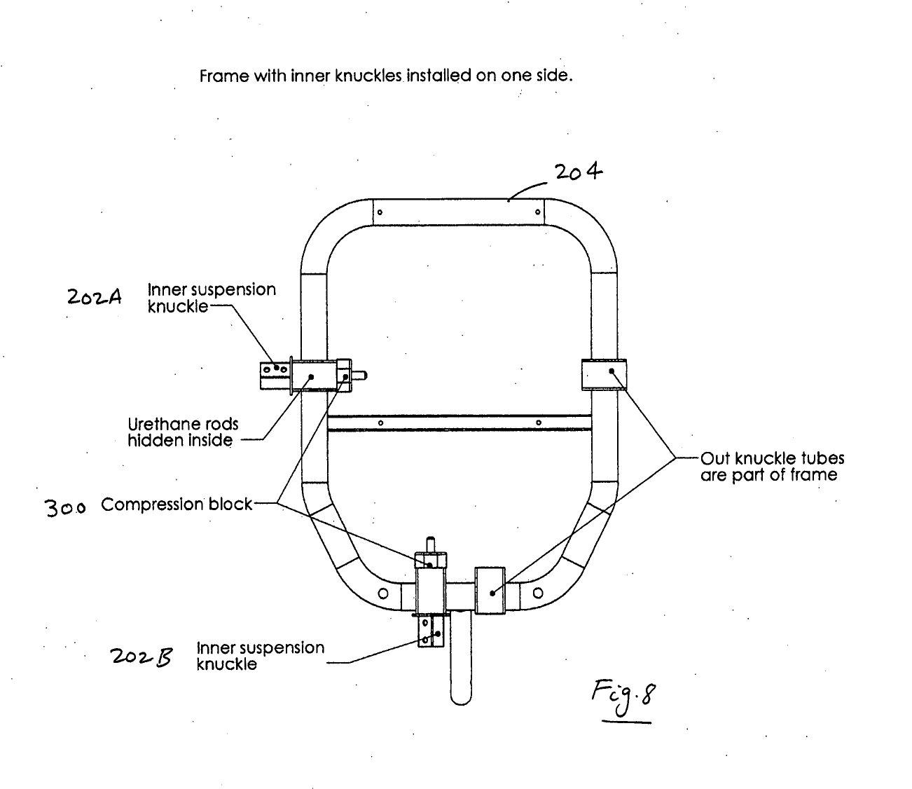

FIG. 7A shows is an exemplary perspective view of a four-wheeled vehicle in which the front steered wheels and the rear driven wheels are provided with the torsional shock absorbers for the cantilevered mount of the vehicle wheels. The torsional shock absorbers which form a part of the suspension system are described above.

FIG. 7B shows a detailed view corresponding to the vehicle of FIG. 7A, shown without the seat. Shown in FIG. 7B, the four-wheeled vehicle includes a frame 204 that lies substantially horizontal. The frame 204 can support 4 suspension knuckles 202A-D or torsional shock absorbers that connect with each of the wheels. The vehicle is powered by a motor 206. The motor is mounted to the frame by a pivoting motor mount. The pivoting motor mount 208 is described in further detail in copending patent application Ser. No. 10/860,896, (Atty Docket No. 015564-003300US), the disclosure of which is incorporated by reference herein. The front wheels are steered by the operator using the handlebar 210. The movement of the handlebar 210 is transferred to the front wheels via the steering column 212 and the steering tie rod 214. The front wheels are connected with the frame 204 via front swing arm(s) 216. The rear wheels are connected with the frame 204 via the trailing link(s) 218.

FIG. 7C shows a top view diagram corresponding to the vehicle of FIG. 7B. As is shown in this figure, the rear assembly, which includes the rear wheels, the motor 206 and mount 208 and the trailing links 218 can move together.

FIG. 7D shows a front view diagram corresponding to the vehicle of FIG. 7B. In FIG. 7D, the front bumper shown in FIGS. 7A-C and 7E is removed for clarity.

FIG. 7E shows a side view diagram corresponding to the vehicle of FIG. 7B.

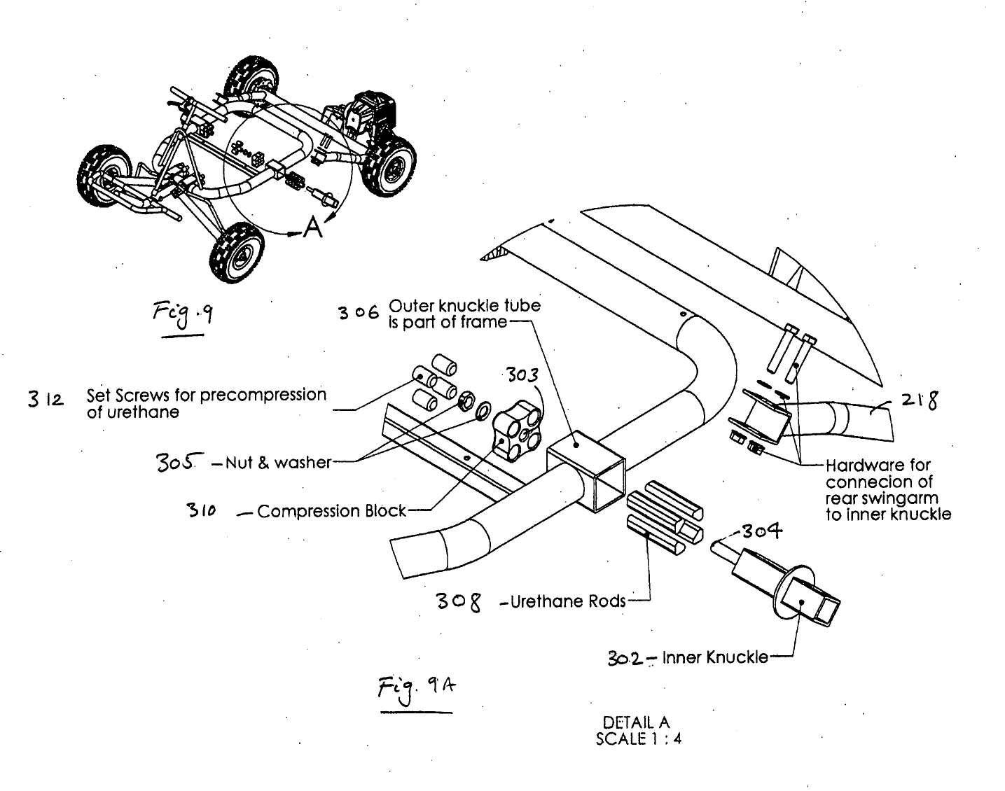

FIG. 8 shows top view diagram of the frame portion 204 of the vehicle of FIG. 7B. This figure shows the torsional shock absorbers 202A-B installed on one side. FIG. 8 shows that the outer tube of the shock absorber can be a part of the frame 204. FIG. 8 also shows the compression block 300 that is used for the pre-compression of the rubber or other rubber-like synthetic material of the torsional shock absorbers 202A-D. It should be realized that the term knuckle and torsional shock absorber can be synonymous as used herein. This novel pre-compression is described below and shown in FIG. 9.

FIG. 9 shows a perspective view diagram showing an exploded view of one of the torsional shock absorbers for the cantilevered mount of the vehicle wheels. FIG. 9A shows detail A corresponding to FIG. 9. As shown in FIG. 9A, the inner knuckle piece 302 has an extended end 304. Once assembled into the outer knuckles tube 306, the inner knuckle is surrounded by the rubber or urethane rods 308 within the outer knuckle 306. The extended end 304 of the inner knuckle 302 fits through aperture 303 in compression block 310. The extended end 304 engages fasteners 305 holding the compression block 310 against the rods 308. Set screws 312 engage the compression block 303 and are configured to push against the rods 308. A tightening of the set screws 312 further compresses the rods 308, which creates a tighter or stiffer suspension. A loosening of the set screws 312 provides for less compression of the rods 308, which creates a looser or less stiff suspension. FIG. 9A also shows how the trailing links 212 connect with the inner tube of the suspension knuckle 302; a top view of the connection is shown in FIG. 7C.

FIG. 10 shows a detailed perspective view diagram of the front swing arm assembly for the vehicle of FIG. 7B. FIG. 10 shows that bracket 217 slides over the inner tube of the suspension knuckles and connects with it using fasteners. Also bracket 219 attaches to spindles and the front wheels mount on the spindles.

The above description is illustrative and is not restrictive, and as it will become apparent to those skilled in the art upon review of the disclosure, the present invention may be embodied in other specific forms without departing from the essential characteristics thereof. These other embodiments are intended to be included within the scope of the present invention. The scope of the invention should, therefore, be determined not with reference to the above description, but instead should be determined with reference to the following and pending claims along with their full scope or equivalents.

What is claimed is:

1. A vehicle with two wheels spaced apart in the travel direction, comprising:
a main structural tube disposed along a longitudinal axis;
a front steered wheel supported from a forward end of the main structural tube;
a rear driven wheel supported from a rear end of the main structural tube;
a torsion acting shock absorber for the cantilevered shock absorbing support of at least one of the vehicle wheels from the main structural tube, said torsion acting shock absorber including
a torsion acting shock absorber attached at a right angle to the main structural tube and protruding to one side of the main structural tube;
a cantilevered wheel support mount offset from the main structural tube at one end of the shock absorber remote from the main structural tube;
the cantilevered wheel support mounted for torsion acting shock absorber rotation through the shock absorber normal to the main structural tube to undertake shock absorbing movement between at least one of the wheels and the main structural tube.

2. The vehicle of claim 1 further comprising a seat connected with said main structural tube.

3. The vehicle of claim 1 wherein the torsion acting shock absorber extends between the main structural tube and the rear driven wheel.

4. The vehicle of claim 1 wherein the torsion acting shock absorber extends between the main structural tube and the front steered wheel.

5. The vehicle of claim 1 wherein the torsion acting shock absorber includes a square sectioned metal tube, a correspondingly square sectioned metal shaft, and confined compressible resilient compound rods acting there between.

6. The vehicle of claim 5 wherein the square sectioned metal tube is fastened at right angles to the main structural tube.

7. The vehicle of claim 5 further comprising a compression block connected with one end of the compressible resilient compound rods confining said resilient compound rods along their longitudinal direction.

8. The vehicle of claim 7 further comprising a set screw dimensioned to engage an aperture within said compression block, said set screw configured for adjustably compressing said resilient compound rods.

9. A four-wheeled vehicle, comprising:
a main structural tube disposed along a longitudinal axis;
two front steered wheels supported from a forward end of the main structural tube;
two rear driven wheels supported from a rear end of the main structural tube;
a torsion acting shock absorber for the cantilevered shock absorbing support of each of the vehicle wheels from the main structural tube, said torsion acting shock absorber including
a torsion acting shock absorber attached at a right angle to the main structural tube;
a cantilevered wheel support mount offset from the main structural tube at one end of the shock absorber remote from the main structural tube;
the cantilevered wheel support mounted for torsion acting shock absorber rotation through the shock absorber normal to the main structural tube to undertake shock absorbing movement between the wheels and the main structural tube.

10. The vehicle of claim 9 wherein the torsion acting shock absorber includes a square sectioned metal tube, a correspondingly square sectioned metal shaft, and confined compressible resilient compound rods acting there between.

11. The vehicle of claim 10 wherein the square sectioned metal tube is fastened at right angles to the main structural tube.

12. The vehicle of claim 10 further comprising a compression block connected with one end of the compressible resilient compound rods confining said resilient compound rods along their longitudinal direction.

13. The vehicle of claim 12 further comprising a set screw dimensioned to engage an aperture within said compression block, said set screw configured for adjustably compressing said resilient compound rods.
